(19) United States
(12) Patent Application Publication
(10) Pub. No.: US 2014/0357805 A1
(43) Pub. Date: Dec. 4, 2014

(54) Polyolefin Having Terminal Double Bond and Method of Producing the Same

(71) Applicants: Takashi Sawaguchi, Tokyo (JP); Daisuke Sasaki, Saitama (JP)

(72) Inventors: Takashi Sawaguchi, Tokyo (JP); Daisuke Sasaki, Saitama (JP)

(73) Assignees: SAN-EI KOUGYOU CORPORATION, Saitama (JP); NIHON UNIVERSITY, Tokyo (JP)

(21) Appl. No.: 14/344,480

(22) PCT Filed: Sep. 13, 2012
(86) PCT No.: PCT/JP2012/073478

§ 371 Date: May 22, 2014

(30) Foreign Application Priority Data
Sep. 13, 2011 (JP) 2011-199338

(51) Int. Cl. C08F 110/06

(52) U.S. Cl. CPC C08F 110/06
USPC 525/333.7; 525/55

(57) ABSTRACT

The present disclosure relates to a novel polyolefin having a terminal double bond and a method of producing the same. A polyolefin having a terminal double bond includes a polyolefin having a terminal double bond at either end and a polyolefin having a terminal double bond at one end, which are thermal degradation products of a polyolefin. An average number of terminal vinylidene groups per molecule is 1.3 to 1.9, a number average molecular weight (Mn) is 50,000 to 5,000,000, and a polydispersity index (Mw/Mn) of a molecular weight distribution is less than or equal to 5.0.

### TECHNICAL FIELD

The present disclosure relates to a novel polyolefin having a terminal double bond and a method of producing the same.

### BACKGROUND ART

Polyolefins are used in various applications utilizing properties specific to polymers. For example, polypropylene is characterized by having good oil resistance and chemical resistance at a low cost, as well as a reduced environmental burden.

Accordingly, by introducing a functional group, e.g., a double bond, a hydroxyl group and a carboxyl group into a main chain and a terminal of the polyolefin, and adding reactivity with other monomers and polymers, development of new applications that make use of the properties of the polyolefin can be expected. Generally, there is an attempt to use olefin polymerization or a polymeric reaction of polymer as a method of introducing a functional group. However, the cost is problematic in the olefin polymerization, and, with the polymeric reaction, it is extremely difficult to introduce a functional group to a specific position in a polymer chain.

The inventors disclosed a method of producing an α,ω-diene-oligomer having a double bond at both ends by thermal degradation of isotactic polypropylene (patent document 1). However, since an obtained oligomer has a low molecular weight, a bulk property of a polymer, in other words a polyolefin, was not sufficiently exhibited.

### DOCUMENT LIST

### Patent Document(s)

Patent Document 1: Japanese Laid-Open Patent Publication No. S55-084302

### SUMMARY

### Technical Problem

It is an object of the present disclosure to provide a polyolefin having a double bond at an end of an olefin and a method of producing the same.

### Solution to Problem

The present inventors carried out assiduous studies to attain the above object, and as a result, reached the findings that a polyolefin having a terminal double bond can be obtained at a high yield by controlling thermal degradation of a polyolefin, and completed the present disclosure.

According to an aspect of the present disclosure, a polyolefin having a terminal double bond is provided which includes a polyolefin having a terminal double bond at either end and a polyolefin having a terminal double bond at one end, which are thermal degradation products of a polyolefin,

the polyolefin having a terminal double bond at either end is represented by the following general formula (1):

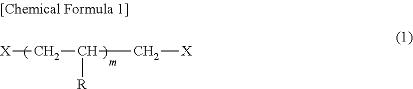

where X is, respectively and independently, one of —CR═CH₂ and —CHR—CH═CR—CH₃, and each R is independently selected from a group consisting of H, —CH₃, —C₂H₅ and —CH₂CH(CH₃)₂, and m is an integer of 1000 to 100,000,

the polyolefin having a terminal double bond at one end is represented by the following general formula (2):

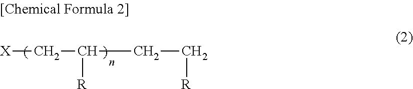

where X is one of —CR═CH₂ and —CHR—CH═CR—CH₃, and each R is independently selected from a group consisting of H, —CH₃, —C₂H₅ and —CH₂CH(CH₃)₂, and n is an integer of 1000 to 100,000,

wherein a number average molecular weight (Mn) is 50,000 to 5,000,000, and a polydispersity index (Mw/Mn) of a molecular weight distribution is less than or equal to 5.0.

Further, the present disclosure relates to the aforementioned polyolefin having a terminal double bond in which R is —CH₃.

Further, the present disclosure relates to the aforementioned polyolefin having a terminal double bond in which X is —CR═CH₂ in the general formulae (1) and (2).

According to an aspect of the present disclosure, a method of producing a polyolefin having a terminal double bond is provided, the polyolefin having a terminal double bond including a polyolefin having a terminal double bond at either end and a polyolefin having a terminal double bond at one end,

the polyolefin having a terminal double bond at either end is represented by the following general formula (1):

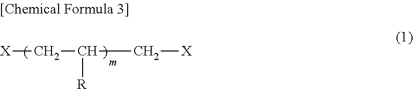

where

X is —CR═CH₂, and each R is independently selected from a group consisting of H, —CH₃, —C₂H₅ and —CH₂CH(CH₃)₂, and m is an integer of 1000 to 100,000),

the polyolefin having a terminal double bond at one end is represented by the following general formula (2):

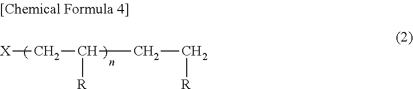

where X is —CR═CH₂, and each R is independently selected from a group consisting of H, —CH₃, —C₂H₅ and —CH₂CH(CH₃)₂, and n is an integer of 1000 to 100,000,

wherein an average number of terminal vinylidene groups per molecule is 1.3 to 1.9, a number average molecular weight (Mn) is 50,000 to 5,000,000, and a polydispersity index (Mw/Mn) of a molecular weight distribution is less than or equal to 5.0,

the method including:

purifying a polyolefin represented by the following general formula (3):

(CH₂—CHR)ₚ (3)

where each R is independently selected from a group consisting of H, —CH₃, —C₂H₅ and —CH₂CH(CH₃)₂, and p is an integer of 3000 to 3,000,000, after the purifying, melting the polyolefin, and carrying out thermal degradation at 330° C. to 370° C. under reduced pressure while bubbling an inert gas.

### Advantageous Effects of Invention

According to the present disclosure, it is possible to provide a novel polyolefin having a terminal double bond, which has a property as a polymer, and a method of producing the same. It can be used in reforming various polymers and as a raw material for producing a functional polymer since the terminal double bond has a good reactivity.

### BRIEF DESCRIPTION OF DRAWINGS

FIG. 1 is a diagram showing a 13C-NMR spectrum of polypropylene having a terminal double bond of Example 1.

FIG. 2 is a diagram showing a 13C-NMR spectrum of polypropylene having a terminal double bond of Reference Examples 1-1 and 1-2.

FIG. 3 is a diagram showing DMA curves of polypropylene having a terminal double bond of Examples 2 to 4.

### DESCRIPTION OF THE PREFERRED EMBODIMENTS

A polyolefin having a terminal double bond at either end according to the present disclosure has a structure represented by the aforementioned general formula (1) and a polyolefin having a terminal double bond at one end according to the present disclosure has a structure represented by the aforementioned general formula (2). Hereinafter, the polyolefin having a terminal double bond at either end and the polyolefin having a terminal double bond at one end are referred to as a polyolefin having a terminal double bond.

In the aforementioned general formula (1), X is, respectively and independently, represented as —CR═CH₂ or —CHR—CH═CR—CH₃. That is, the polyolefin having a terminal double bond at either end includes those having —CR═CH₂ at either end, those having —CHR—CH═CR—CH₃ at either end, those having —CR═CH₂ at one end and —CHR—CH═CR—CH₃ at the other end. In each of the aforementioned formulae, each R is independently selected from a group consisting of H, —CH₃, —C₂H₅ and —CH₂CH (CH₃)₂. In other words, the polyolefin composing a polyolefin chain includes polypropylene (all R's are —CH₃), poly 1-butene (all R's are —C₂H₅), copolymer of ethylene-propylene (R is H or —CH₃), ethylene 1-butene copolymer (R is H or —C₂H₅), propylene 1-butene copolymer (R is —CH₃ or —C₂H₅) or poly 4-methyl-1-pentene (all R's are —CH₂CH(CH₃)₂) or the like. Note that the copolymer includes both a random copolymer and a block copolymer. In the present disclosure, it is preferable that R is —CH₃.

In each of the aforementioned formulae, “m” and “n” represent a number of repeat units of a monomer. “m” and “n” are 1000 to 100,000. Preferably, “m” and “n” are 3000 to 8000.

With the polyolefin having a terminal double bond according to the present disclosure, a number average molecular weight (Mn) obtained by gel permeation chromatography (GPC) is 50,000 to 5,000,000. Preferably, it is 150,000 to 3,000,000. In a case where Mn is less than 50,000, a characteristic as a polymer is not exhibited.

Further, the polyolefin having a terminal double bond according to the present invention has a polydispersity index (Mw/Mn) of the molecular weight distribution of less than or equal to 5.0. Preferably, it is 2.2 to 4.0.

The polyolefin having a terminal double bond according the present disclosure has an average number of terminal vinylidene groups per molecule of 1.3 to 1.9.

The polyolefin having a terminal double bond according to the present disclosure is obtained as thermal degradation products of a polyolefin by controlled thermal degradation (see Macromolecules, 28, 7973 (1995)) developed by the inventors.

A raw material polyolefin is represented by the following general formula (3),

(CH₂—CHR)ₚ (3).

Each R is independently selected from a group consisting of H, —CH₃, —C₂H₅ and —CH₂CH(CH₃)₂. “p” represents a number of repeat units of a monomer and is 3000 to 3,000,000. Preferably, it is 5000 to 2,000,000.

It is preferable to purify the pre-degradation raw material polyolefin. A purifying method may be performed by, for example, dissolving in heated xylene and thereafter pouring into methanol to purify by reprecipitation, but it is not particularly limited thereto. By purifying the pre-degradation raw material polyolefin, it is possible to suppress production of a polyolefin having a trisubstitution double bond (in general formulae (1) and (2), X is —CHR—CH═CR—CH₃) that has a low reactivity and can produce only a polyolefin having a terminal double bond (in general formulae (1) and (2), X is —CR═CH₂) that has a high reactivity.

Taking polypropylene as an example, a thermal degradation product of polypropylene obtained by a controlled thermal degradation method has properties that a number average molecular weight Mn is 50,000 to 5,000,000, a polydispersity index Mw/Mn of a molecular weight distribution is 1.0 to 5.0, an average number of double bonds per molecule is 1.3 to 1.9, and stereoregularity of the pre-degradation raw material polypropylene is maintained. A viscosity average molecular weight of the pre-degradation raw material polypropylene is preferably within a range of 1,000,000 to 100,000,000.

The pre-degradation raw material polypropylene can be produced by a well-known method in the presence of a well-known catalyst such as a Ziegler-Natta catalyst consisting of titanium trichloride and an alkylaluminum compound or a composite catalyst consisting of a magnesium compound and a titanium compound. A preferred production method may be a method of producing, for example, by polymerizing propylene alone or polymerizing propylene and α-olefin in the presence of a catalyst for producing a high stereoregularity polypropylene.

The catalyst for producing a high stereoregularity polypropylene may be, for example, a catalyst consisting of a solid titanium catalyst component containing magnesium, titanium, halogen and an electron donor, an organometal compound and an electron donor. The aforementioned solid titanium catalyst component can be prepared by mixing a magnesium compound, a titanium compound and electron donor.

A thermal degradation apparatus may be an apparatus disclosed in Journal of Polymer Science: Polymer Chemistry Edition, 21, 703 (1983). Polypropylene is placed in glass reaction container of a thermal degradation apparatus made of a pyrex (R) and undergoes thermal degradation reaction at a predetermined temperature for a predetermined time while suppressing secondary reaction by vigorously bubbling a molten polymer phase with nitrogen gas under a reduced pressure to extract a volatile product. After the thermal degradation reaction, the residual in the reaction container is dissolved in heated xylene and, after thermal filtration, reprecipitated with alcohol and purified. A reprecipitated product is filtered, collected, and dried in vacuum to obtain polypropylene having a terminal double bond.

Conditions of thermal degradation are adjusted by predicting a molecular weight of a product from a molecular weight of polypropylene before degradation and a primary construction of a block copolymer of a final product and taking into consideration the result of an experiment performed beforehand. The thermal degradation temperature is preferably in a range of 300° C. to 450° C. More preferably, it is 330° C. to 370° C. At a temperature lower than 300° C., the thermal degradation reaction of polypropylene may not progress sufficiently, and at a temperature higher than 450° C., deterioration of telechelic polypropylene may progress.

### EXAMPLE

Hereinafter, the present disclosure will be described in detail using examples, but the present disclosure is not limited thereto. In each of the example, molecular weights were measured with a GPC analysis apparatus (HLC-8121GPC/HT (manufactured by Tosoh Corporation)). In the measurements, measurements were carried out using orthodichlorobenzene as a mobile phase and a polystyrene equivalent molecular weight was derived. Also, in the examples, ECA600 was used for 13C-NMR (600 MHz) and JNM-ECP500 (manufactured by JEOL Ltd.) was used for Reference Examples 13C-NMR (500 MHz) to measure with hexamethyl disiloxane standards using a mixed solvent of deuterated benzene and 1,2,4-trichlorobenzene.

[Synthesis of Polyolefin (iPP-H) having Terminal Double Bond]

With a method described below, a polyolefin (iPP-H) having a terminal double bond was synthesized.

### Example 1

A small-sized thermal degradation apparatus made of glass was used as a thermal degradation apparatus. 5 g of isotactic polypropylene, which is Mw=68,500,000 converted in viscosity, was placed in a reactor, and with a system being depressurized to 2 mmHg after nitrogen purging, melted by heating the reactor to 200° C. Thereafter, the reactor was dipped into a metal bath set at 370° C. and thermal degradation was performed. During the thermal degradation, the system was kept at a reduced pressure state of about 2 mmHg and melted polymer was stirred by bubbling with nitrogen gas discharged from a capillary introduced therein. After one hour, the reactor was removed from the metal bath and cooled to room temperature. Thereafter, the reaction system was brought to normal pressure. The residue in the reactor was dissolved in heat xylene and thereafter dropped in methanol and purified by reprecipitation. The obtained polymer had a yield of 96%, a number average molecular weight (Mn) of 96,000 and a polydispersity index (Mw/Mn) of 2.2.

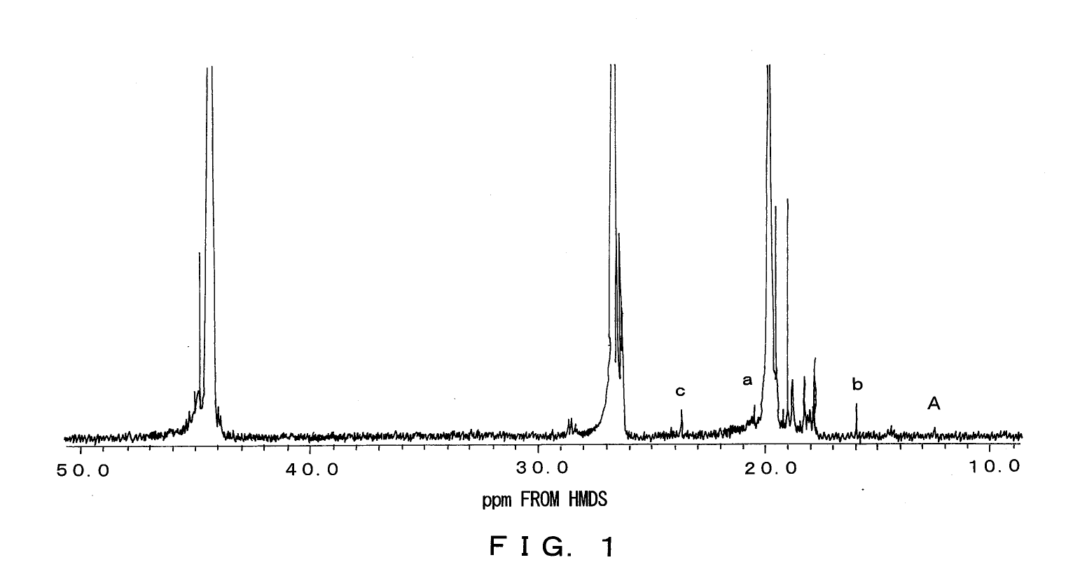

At first, a structural analysis was performed using a thermal degradation product for determining a terminal group. With a 1H-NMR spectrum and a 13C-NMR spectrum of a collected thermal degradation product, it was confirmed that a thermal degradation product was an isotactic polypropylene having a terminal double bond. The 13C-NMR spectrum of the thermal degradation product is shown in FIG. 1. A signal (A) of 12.5 ppm in the 13C-NMR is derived from an n-propyl terminal carbon. A signal (a) of 20.5 ppm is derived from methyl carbon of a terminal vinylidene, and a signal (b) of 15.8 ppm and a signal (c) of 23.7 ppm are derived from methyl carbons of a terminal trisubstitution double bond. Note that the terminal trisubstitution double bond was produced due to the remaining polymerization catalyst. An average number of the double bond per molecule obtained from a signal intensity ratio of these terminal groups was 1.65.

### Example 2

In a method similar to Example 1, reaction was carried out with the thermal degradation temperature being changed from 370° C. to 350° C. The obtained polymer had a yield of 99%, a number average molecular weight (Mn) of 253,000 and a polydispersity index (Mw/Mn) of 3.1.

### Example 3

In a method similar to Example 2, reaction was carried out with the reaction time being changed from one hour to two hours. The obtained polymer had a yield of 99%, a number average molecular weight (Mn) of 178,000, and a polydispersity index (Mw/Mn) of 2.9.

### Example 4

In a method similar to Example 3, reaction was carried out with the thermal degradation temperature being changed from 350° C. to 330° C. The obtained polymer had a yield of 99%, a number average molecular weight (Mn) of 282,000, and a polydispersity index (Mw/Mn) of 3.8.

### Reference Example 1-1

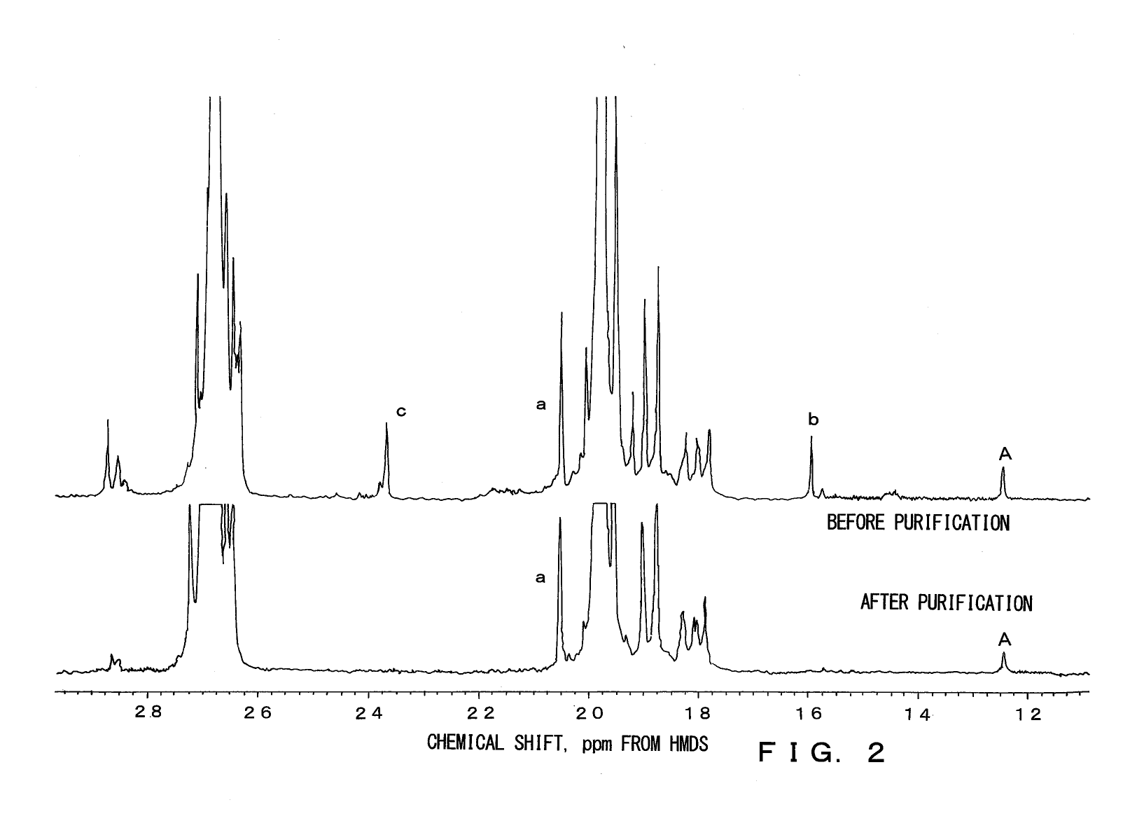

In a method similar to Example 1, reaction was carried out with the thermal degradation temperature being changed from 370° C. to 390° C. and the reaction time being changed from one hour to three hours. The obtained polymer had a yield of 53%, a number average molecular weight (Mn) of 11,000, and a polydispersity index (Mw/Mn) of 2.2. A 13C-NMR spectrum of a thermal degradation product is shown at an upper part in FIG. 2. An average number of double bond per molecule derived from a signal intensity ratio of the terminal group by the 13C-NMR measurement was 1.79.

### Reference Example 1-2

Isotactic polypropylene, which is Mw=68,500,000 converted in viscosity, was dissolved in heated xylene and thereafter dropped in methanol and purified by reprecipitation. In a method similar to Reference Example 1-1, reaction was carried out. The obtained polymer had a yield of 54%, a number average molecular weight (Mn) of 12,000, and a polydispersity (Mw/Mn) of 2.2.

The 13C-NMR spectrum of the thermal degradation product is shown at a lower part in FIG. 2. A signal (A) of 12.5 ppm with the 13C-NMR is derived from an n-propyl terminal carbon. A signal (a) of 20.5 ppm is derived from a methyl carbon of the terminal vinylidene. The signal (b) of 15.8 ppm and the signal (c) of 23.7 ppm observed in the 13C-NMR spectrum of the product in Reference Example 1-1 disappeared. In other words, it can be seen that it was possible to suppress the production of the terminal trisubstitution double bond by purifying the raw material. The average number of double bond per molecule derived from the signal intensity ratio of these terminal groups was 1.79.

### Reference Example 2

In a method similar to Reference Example 1-1, reaction was carried out with the reaction time being changed from three hours to one hour. The obtained polymer had a yield of 91%, a number average molecular weight (Mn) of 42,000, and a polydispersity index (Mw/Mn) of 2.3.

Similarly to Reference Example 1-2, it was found that also in Examples 1 to 4, it was possible to suppress the production of the terminal trisubstitution double bond by purifying the raw material.

The polymers obtained in Examples 1 to 4, Reference Example 1-1 and Reference Example 2 were heat pressed at 200° C., respectively, and, a moldability was evaluated. The result showed that films were not fabricated with the polymers of Reference Example 1-1 and Reference Example 2 at all. On the other hand, the polymer of Example 1 had a good moldability, and particularly, the polymer of Examples 2 to 4 had a superior moldability.

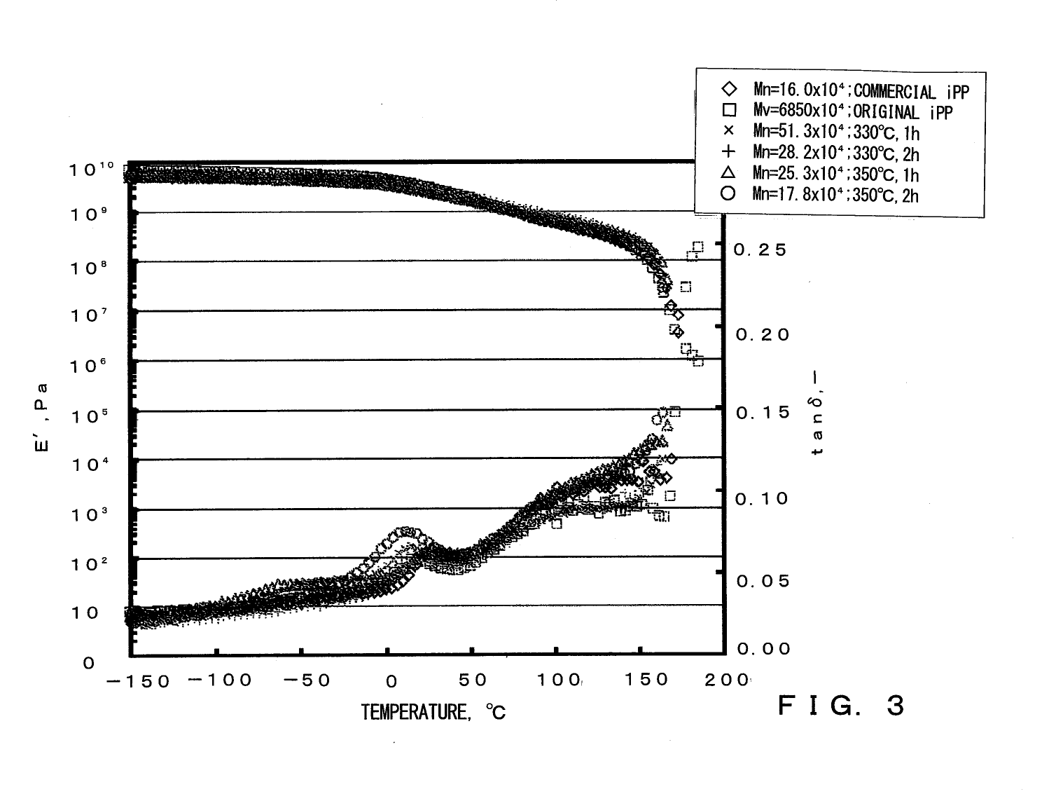

FIG. 3 shows DMA curves for a general commercial isotactic polypropylene (commercial iPP), isotactic polypropylene having viscosity converted Mw=68,500,000 (original iPP), and the polymers of Examples 2 to 4, respectively. A peak of tan δ and the lowering of E′ around 0° C. originate from the glass-transition temperature. Also, it melted and broke at around 160° C. that is a crystalline melting temperature of the isotactic polypropylene. These results almost correspond in all samples and show that even if the molecular weight decreases after thermal degradation and double bonds are introduced, there is not much influence on physical properties.

The polyolefin of the present disclosure has a double bond at one end or both ends and an average number of double bonds per molecule is large. In the related art, it was not possible to obtain such a polyolefin having a large molecular weight and further having a terminal double bond. Also, the polyolefin of the present disclosure has a terminal double bond and thus can be copolymerized with another olefin including ethylene, propylene and isoprene, a diolefin such as butadiene and isoprene, and a monomer having a vinyl double bond such as styrene, acrylate, and methacrylate, and a copolymer thereof can be reformed by incorporating the characteristics of the polyolefin. Also, since a functional group such as a hydroxyl group and a carboxy group can be introduced at an end of a polymeric chain by making use of a terminal double bond, it can be used in reforming various polymers and can be used as a raw material for producing a functional polymer.

1. A polyolefin having a terminal double bond, including a polyolefin having a terminal double bond at either end and a polyolefin having a terminal double bond at one end, which are thermal degradation products of a polyolefin,
the polyolefin having a terminal double bond at either end is represented by the following general formula (1): 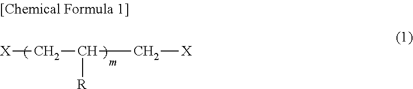
where X is, respectively and independently, one of —CR═CH₂ and —CHR—CH═CR—CH₃, and each R is independently selected from a group consisting of H, —CH₃, —C₂H₅ and —CH₂CH(CH₃)₂, and m is an integer of 1000 to 100,000,
the polyolefin having a terminal double bond at one end is represented by the following general formula (2): 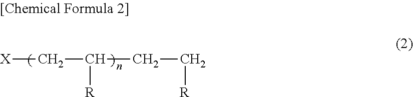
where X is one of —CR═CH₂ and —CHR—CH═CR—CH₃, and each R is independently selected from a group consisting of H, —CH₃, —C₂H₅ and —CH₂CH(CH₃)₂, and n is an integer of 1000 to 100,000,
wherein an average number of terminal vinylidene groups per molecule is 1.3 to 1.9, a number average molecular weight (Mn) is 150,000 to 5,000,000, and a polydispersity index (Mw/Mn) of a molecular weight distribution is less than or equal to 5.0.

2. The polyolefin having a terminal double bond according to claim 1, wherein R is CH₃.

3. The polyolefin having a terminal double bond according to claim 1, wherein X is —CR═CH₂ in the general formulae (1) and (2).

4. A method of producing a polyolefin having a terminal double bond, including a polyolefin having a terminal double bond at either end and a polyolefin having a terminal double bond at one end,
the polyolefin having a terminal double bond at either end is represented by the following general formula (1): 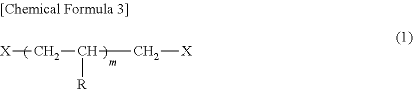
where
X is —CR═CH₂, and each R is independently selected from a group consisting of H, —CH₃, —C₂H₅ and —CH₂CH(CH₃)₂, and m is an integer of 1000 to 100,000,
the polyolefin having a terminal double bond at one end is represented by the following general formula (2): 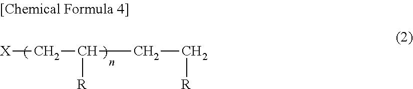
where X is —CR═CH₂, and each R is independently selected from a group consisting of H, —CH₃, —C₂H₅ and —CH₂CH(CH₃)₂, and n is an integer of 1000 to 100,000,
wherein an average number of terminal vinylidene groups per molecule is 1.3 to 1.9, a number average molecular weight (Mn) is 150,000 to 5,000,000, and a polydispersity index (Mw/Mn) of a molecular weight distribution is less than or equal to 5.0,
the method comprising:
purifying a polyolefin represented by the following general formula (3):
(CH₂—CHR)ₚ (3)
where each R is independently selected from a group consisting of H, —CH₃, —C₂H₅ and —CH₂CH(CH₃)₂, and p is an integer of 3000 to 3,000,000, after the purifying, melting the polyolefin, and carrying out thermal degradation at 330° C. to 370° C. under reduced pressure while bubbling an inert gas.
